(19) United States
(12) Patent Application Publication
(10) Pub. No.: US 2009/0158885 A1
(43) Pub. Date: Jun. 25, 2009

(54) Pedal extension apparatus

(76) Inventor: Donald J. Therrien, The Villages, FL (US)

Correspondence Address: LAW OFFICE OF STEVEN R. OLSEN, PLLC, P.O. BOX 2092, INVERNESS, FL, 34451-2092, US

(21) Appl. No.: 12/004,552

(22) Filed: Dec. 21, 2007

(51) Int. Cl. G05G 1/16

(52) U.S. Cl. 74/562

(57) ABSTRACT

The invention relates generally to a pedal extension apparatus for use with a mechanical control lever. In embodiments of the invention, the pedal extension apparatus includes a platform configured to rest on a top surface of a pedal; and a vertical retainer coupled to the platform, the vertical retainer and a bottom surface of the platform configured to circumnavigate the pedal, the vertical retainer thus configured to secure the pedal extension apparatus to the pedal, the pedal extension apparatus not including a fastener.

### BACKGROUND AND SUMMARY

1. Field of the Invention

The invention relates generally to mechanical control levers, and more particularly, but without limitation, to a pedal extension apparatus for use with a mechanical control lever.

2. Description of the Related Art

Foot pedals (hereinafter pedals) are commonly included as an element of control levers that are found on automobiles, golf carts, and other machines. For example, a foot pedal may be used on control levers associated with an accelerator, a brake and/or a clutch of an automobile. The position between a pedal and an operator's seating position may be fixed or limited in adjustment, however. Thus, operators with short leg dimensions may not be able to reach the pedal and operate the control lever.

Pedal extensions are known in the art. Such pedal extensions typically attach to an existing pedal element of the control lever. Conventional pedal extensions have many disadvantages, however. For instance, known pedal extensions use nuts, bolts, wing nuts, screws, adjustable clamps, and/or other fasteners to mechanically join the pedal extension to the non-extended pedal element. But such fasteners may be difficult and/or time consuming for users to install and/or uninstall. Moreover, fasteners may loosen during operation, creating an unsafe condition for the operator, passengers, bystanders, or others.

One alternative is to permanently join a pedal extension to a control lever, for instance using a welding process. But such permanent attachment may be disadvantageous to a user who wishes to use the pedal extension only on a temporary basis. For instance, a short operator may share a vehicle with a tall operator. In addition, an operator may only use a vehicle on a temporary basis, for example when renting an automobile or golf cart.

For at least the foregoing reasons, an improved pedal extension apparatus is needed for use with mechanical control levers.

### SUMMARY OF THE INVENTION

Embodiments of the invention provide a pedal extension apparatus that is configured to affix to a pedal without the use of a fastener.

An embodiment of the invention provides a pedal extension apparatus that includes: a platform configured to rest on a top surface of a pedal; and a vertical retainer coupled to the platform, the vertical retainer and a bottom surface of the platform configured to circumnavigate the pedal, the pedal extension apparatus not including a fastener.

Another embodiment of the invention provides a pedal extension apparatus that includes: a platform configured to communicate with a top surface of a pedal, the outside dimensions of the platform having the shape of a rectangular parallelepiped, the platform having a top side, a bottom side, a first short side, a second short side, a first long side, and a second long side; a first vertical retainer coupled to the first long side of the platform, the first vertical retainer having an L-shaped cross-section, the first vertical retainer configured to communicate with a bottom surface of the pedal; a second vertical retainer coupled to the second long side of the platform, the first vertical retainer having an L-shaped cross-section the second vertical retainer configured to communicate with the bottom surface of the pedal; and an endplate coupled to the first short side of the platform, the endplate configured to communicate with an end of the pedal, the pedal extension apparatus not including a fastener.

### BRIEF DESCRIPTION OF THE DRAWINGS

The present invention will be more fully understood from the detailed description below and the accompanying drawings, wherein:

FIG. 1 is a perspective view of a pedal extension apparatus, according to an embodiment of the invention;

FIG. 2 is a side view of the pedal extension apparatus, according to an embodiment of the invention;

FIG. 3 is a bottom view of a pedal extension apparatus, according to an embodiment of the invention;

FIG. 4 is a flow diagram of a method for manufacturing a pedal extension apparatus, according to an embodiment of the invention;

FIG. 5 is an exploded view of a platform apparatus, according to an embodiment of the invention;

FIG. 6 is an exploded view of a pedal extension assembly, according to an embodiment of the invention;

FIG. 7 is a bottom view of a pedal extension apparatus, according to an embodiment of the invention; and

FIG. 8 is an exploded view of a pedal extension apparatus, according to an embodiment of the invention.

### DETAILED DESCRIPTION

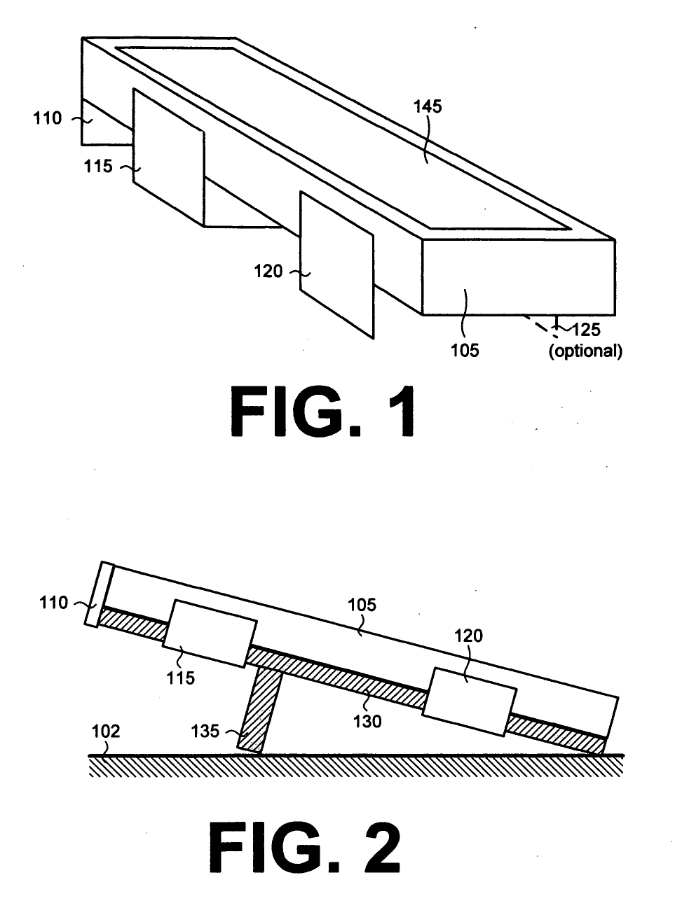

Embodiments of the present invention will now be described more fully with reference to FIGS. 1 through 8, in which embodiments of the invention are shown. This invention may, however, be embodied in many different forms and should not be construed as limited to the embodiments set forth herein.

FIG. 1 is a perspective view of a pedal extension apparatus, according to an embodiment of the invention. In the illustrated embodiment, the pedal extension apparatus includes a platform 105. An endplate 110, a vertical retainer 115, and a horizontal retainer 120 are coupled to the platform 105. A horizontal retainer 125 may be coupled to an opposite side of the platform 105 from the horizontal retainer 120.

At least a portion of the top surface of the platform 105 may include a non-skid surface 145. The non-skid surface 145 may be, for example, an etched surface of the platform 105. Alternatively, the non-skid surface 145 may be an applied surface, such as anti-slip tape having a grit sandpaper surface and adhesive backing. Such anti-slip tape is available in rolls or pre-cut strips from Uline Shipping Supplies and other retailers. The purpose of the non-skid surface 145 is to provide friction between the top surface of the platform 105 and, for instance, the bottom surface of an operator's shoe. At least a portion of a bottom surface of the platform 105 may also include a non-skid surface (discussed further below, but not shown in FIG. 1).

The outside dimensions of the platform 105 may form a rectangular box (a/k/a a cuboid, a rectangular prism, or a rectangular parallelepiped). More generally, the platform 105 may be any parallelepiped (i.e., any hexahedron formed by six parallelograms), any hexahedron (i.e., any six-sided polyhedron), or any other three-dimensional shape that is configured to couple to a pedal. The platform 105, or its surfaces, need not be solid. In embodiments of the invention, the vertical retainer 115 has a u-shaped cross-section (visible in FIG. 6).

The platform 105 may be constructed of any variety of materials, for example, metal or alloy tubing, and/or a non-metallic material. The endplate 110, the vertical retainer 115, and the horizontal retainers 120 and 125 may likewise be constructed of a metal or alloy plates, and/or a non-metallic material, according to design choice. As an example, each of the endplate 110, the vertical retainer 115, and the horizontal retainers 120 and 125 may be ⅛ inch thick 6063-T52 aluminum.

Variations to the configuration shown in FIG. 1 are possible. For example, the platform 105 may be a non-rectangular parallelepiped or other shape. In addition, the pedal extension apparatus may include only the horizontal retainer 120, only the horizontal retainer 125, both horizontal retainers 120 and 125, or no horizontal retainers, based on application needs. Further, instead of a single non-skid surface 145 on a top surface of the platform 105, there could be multiple non-skid surfaces on the top surface of the platform 105. For instance, an alternative embodiment could include multiple strips of anti-slip tape, where each of the multiple strips is positioned parallel to a long axis of the platform 105. Or there could be multiple strips of anti-slip tape where each of the multiple strips is positioned parallel to a short axis of the platform 105. Alternatively, the non-skid surface 145 could include an array of circular or elliptical anti-slip contact features. Other variations are also possible.

FIG. 2 is a side view of the pedal extension apparatus, according to an embodiment of the invention. FIG. 2 illustrates the pedal extension apparatus of FIG. 1 assembled to a pedal 130. The pedal 130 is coupled to an arm 135. The combined assembly of the pedal extension apparatus and the pedal 130 is suspended above a surface 102. The surface 102 may be, for instance, an interior floor surface of an automobile, golf cart, or other vehicle.

As shown in FIG. 2, a top surface of the pedal 130 is in communication with a bottom surface of the platform 105. A non-skid surface on the bottom of the platform 105 (not shown in FIG. 2) may be used to provide friction between the bottom surface of the platform 105 and the top surface of the pedal 130.

The vertical retainer 115 is in communication with a bottom surface of the pedal 130, the horizontal retainer 120 is in communication with a side surface of the pedal 130, and the endplate 110 is in communication with an end surface of the pedal 130. A thickness of the platform 105 thus effectively extends a top surface of the pedal 130 toward an operator's seating position by a distance that is approximately equal to the thickness of the platform 105.

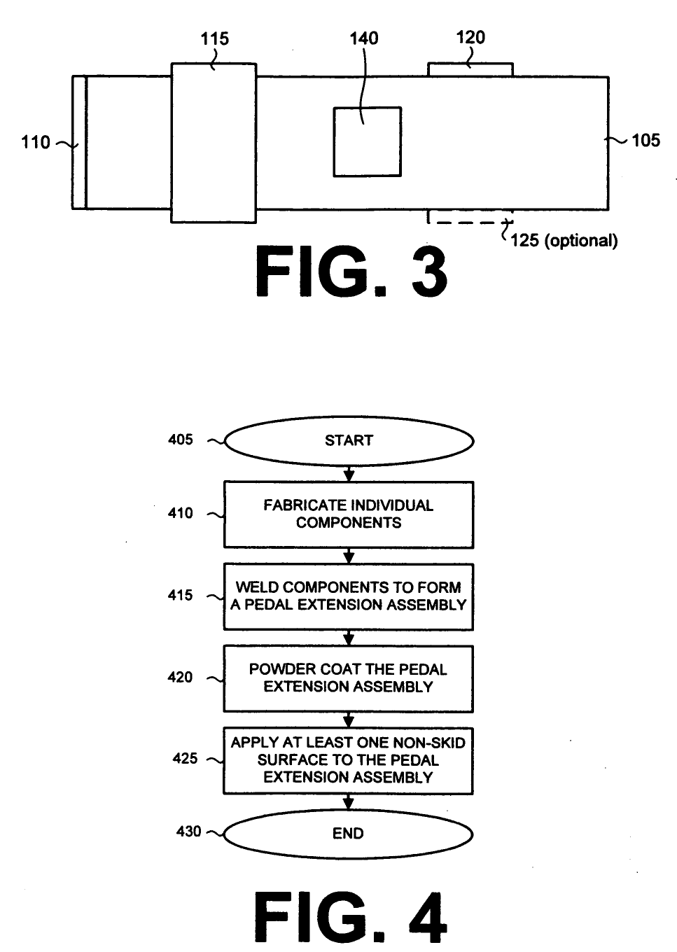

FIG. 3 is a bottom view of a pedal extension apparatus, according to an embodiment of the invention. FIG. 3 illustrates that the endplate 110 and the vertical retainer 115 may extend the full width of the platform 105. FIG. 3 further illustrates a non-skid surface 140 on the bottom surface of the platform 105. Like the non-skid surface 145, the non-skid surface 140 may be formed in the platform 105 (e.g., through an etching process) or the non-skid surface 140 may be applied (e.g., using anti-slip tape) to the surface of the platform 105. When the pedal extension apparatus is assembled to the pedal 130, the non-skid surface 140 provides friction between the bottom surface of the platform 105 and the top surface of the pedal 130.

Variations to the embodiment illustrated in FIG. 3 are possible. For example, the end plate 110 need not extend the full width of the platform 105. Moreover, the position, relative size, and/or shape of the non-skid surface 140 may be varied to achieve a desired frictional force between the platform 105 and the pedal 130.

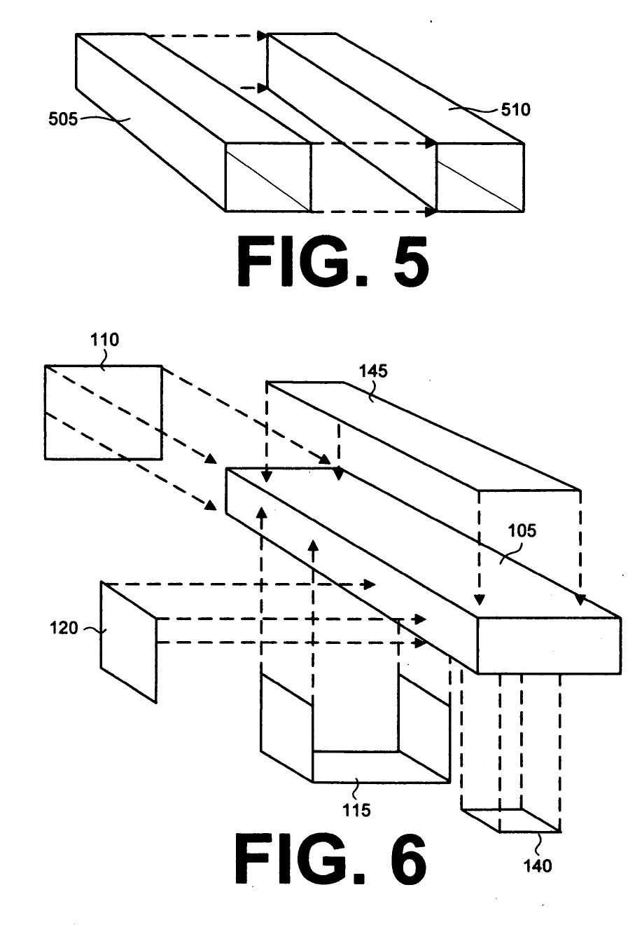

FIG. 4 is a flow diagram of a method for manufacturing a pedal extension apparatus, according to an embodiment of the invention. After beginning in step 405, the process fabricates individual components in step 410. Step 410 may include, for example, cutting each of the endplate 110, vertical retainer 115 and horizontal retainer 120 to desired dimensions from flat metal stock. With respect to the vertical retainer 115, step 410 may further include bending a piece of flat metal stock, for instance using a press brake. Alternatively, the vertical retainer 115 could be made by joining three substantially flat metal pieces, for example by welding or brazing. One way to fabricate the platform 105 will be described below with reference to FIG. 5.

The process welds the endplate 110, vertical retainer 115 and horizontal retainer 120 to platform 105 in step 415 to form a pedal extension assembly. In step 420, the process powder coats the pedal extension assembly to apply a hard protective finish. The powder coat material used in step 420 may be, for instance, a thermoset polymer or a thermoplastic. A non-skid surface is then applied to at least one surface of the pedal extension assembly in step 425 before the process terminates in step 430. Step 425 may include applying non-skid surface 145 to a top surface of the platform 105 and/or applying non-skid surface 140 to a bottom surface of the platform 105. Where the non-skid surfaces 140 and 145 are made with anti-slip tape, step 425 may include cutting the anti-slip tape to a desired size, and pressing an adhesive-backed side of the anti-slip tape onto the desired portion(s) of the platform 105.

Variations to the process flow illustrated in FIG. 4 are possible. For example, step 415 may include brazing, adhesive bonding, or other methods for joining individual components into an assembly. Step 420 may alternatively include painting, anodizing, and/or other process steps to achieve a desired cosmetic appearance and/or to increase the wear resistance of the pedal extension assembly. In alternative embodiments, step 425 may be eliminated.

FIG. 5 is an exploded view of a platform apparatus, according to an embodiment of the invention. FIG. 5 illustrates that the plaform 105 may be fabricated by welding, brazing, or otherwise joining two square tubes 505 and 510. Each of the tubes 505 and 510 may be, for example, 6063-T52 aluminum having ⅛ inch thick walls and an outer dimension of 1¼ inch ×1¼ inch ×6 inches. In this instance, the platform 105 that is fabricated by joining the square tubes 505 and 510 has a thickness of 1¼ inch, a width of 2½ inches, and a length of 6 inches. Other quantities and sizes of tubing could be joined, according to design choice. FIG. 5 also illustrates that all surfaces of the platform 105, in this case the short sides, need not be solid.

FIG. 6 is an exploded view of a pedal extension assembly, according to an embodiment of the invention. FIG. 6 illustrates the assembly of the endplate 110, vertical retainer 115, horizontal retainer 120, and non-skid surfaces 140 and 145 onto the platform 105. The platform 105 has six sides: a top side, a bottom side, a first short side, a second short side, a first long side, and a second long side. The endplate 110 is coupled to the first short side. The vertical retainer 115 is coupled to the first long side and the second long side, while passing under the bottom side. The horizontal retainer 120 is coupled to the first long side. The non-skid surface 140 is coupled to the bottom side and the non-skid surface 145 is coupled to the top side.

Variations to the assembly illustrated in FIG. 6 are possible. For example, a horizontal retainer 125 could be coupled to the second long side instead of, or in combination with, the assembly of the horizontal retainer 120 that is coupled to the first long side. The relative sizes of each component, and the position with respect to the platform 105, can be adjusted, according to design choice.

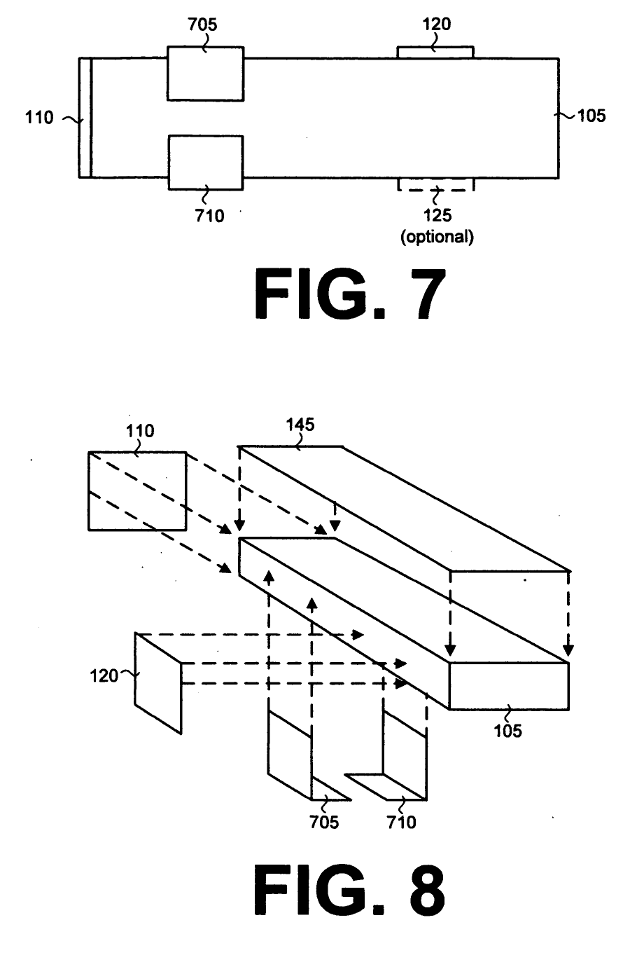

FIGS. 7 and 8 illustrate an alternative embodiment of pedal extension apparatus. FIG. 7 is a bottom view of the pedal extension apparatus; FIG. 8 is an exploded view of the pedal extension apparatus illustrated in FIG. 7. A description of features discussed above will be omitted. In the embodiment illustrated in FIGS. 7 and 8, the vertical retainer 115 is replaced by vertical retainers 705 and 710. Each of the vertical retainers 705 and 710 has an L-shaped cross-section.

Embodiments of the invention provide many benefits. For example, embodiments of the pedal extension apparatus effectively extend a top surface of a pedal toward an operator's seating position. Advantageously, in embodiments of the invention, the pedal extension apparatus is assembled to a pedal without the use of a fastener. Thus, the pedal extension apparatus can be installed or uninstalled quickly and easily.

It will be apparent to those skilled in the art that modifications and variations can be made without deviating from the spirit or scope of the invention. For example, alternative features described herein could be combined in ways not explicitly illustrated or disclosed. Thus, it is intended that the present invention cover any such modifications and variations of this invention provided they come within the scope of the appended claims and their equivalents.

What is claimed is:

1. A pedal extension apparatus comprising:
a platform configured to rest on a top surface of a pedal; and
a vertical retainer coupled to the platform, the vertical retainer and a bottom surface of the platform configured to circumnavigate the pedal, the vertical retainer thus configured to secure the pedal extension apparatus to the pedal, the pedal extension apparatus not including a fastener.

2. The pedal extension apparatus of claim 1, wherein the pedal extension apparatus includes a powder-coated finish.

3. The pedal extension apparatus of claim 1, wherein the platform and the vertical retainer are formed out of aluminum.

4. The pedal extension apparatus of claim 1, further comprising a non-skid surface on at least a portion of a top surface of the platform, the non-skid surface being a relatively high-friction surface.

5. The pedal extension apparatus of claim 1, further comprising a non-skid surface on at least a portion of the bottom surface of the platform, the non-skid surface configured to provide a relatively high-friction interface between the bottom surface of the platform and a top surface of the pedal.

6. The pedal extension apparatus of claim 5, wherein the non-skid surface includes non-slip tape.

7. The pedal extension apparatus of claim 1, wherein the vertical retainer has a substantially u-shaped cross-section.

8. The pedal extension apparatus of claim 1, wherein outside dimensions of the platform form a hexahedron, the hexahedron including a top side, a bottom side, a first short side, a second short side, a first long side, and a second long side.

9. The pedal extension apparatus of claim 8, wherein the hexahedron is a parallelepiped.

10. The pedal extension apparatus of claim 9, wherein the parallelepiped is a rectangular parallelepiped.

11. The pedal extension apparatus of claim 8, wherein the vertical retainer is coupled to the first long side and the second long side.

12. The pedal extension apparatus of claim 8, further comprising an endplate coupled to the first short side, the endplate configured to communicate with an end surface of the pedal, the endplate being substantially flat and substantially rectangular.

13. The pedal extension apparatus of claim 12, further comprising a first horizontal retainer coupled to the first long side, the first horizontal retainer configured to communicate with a first side surface of the pedal, the first horizontal retainer being substantially flat and substantially rectangular.

14. The pedal extension apparatus of claim 13, further comprising a second horizontal retainer coupled to the second long side, the second horizontal retainer configured to communicate with a second side surface of the pedal, the second horizontal retainer being substantially flat and substantially rectangular.

15. The pedal extension apparatus of claim 13, wherein the vertical retainer has a substantially u-shaped cross-section.

16. The pedal extension apparatus of claim 15, further comprising a first non-skid surface on at least a portion of a top surface of the platform, the first non-skid surface being a relatively high-friction surface.

17. The pedal extension apparatus of claim 16, further comprising a second non-skid surface on at least a portion of the bottom surface of the platform, the second non-skid surface configured to provide a relatively high-friction interface between the bottom surface of the platform and a top surface of the pedal.

18. The pedal extension apparatus of claim 17, wherein the platform, the vertical retainer, the endplate, and the first horizontal retainer are formed out of aluminum.

19. The pedal extension apparatus of claim 8, wherein the platform includes a first tube having a first square cross-section coupled to a second tube having a second square cross-section, the dimensions of the first tube being substantially equal to the dimensions of the second tube.

20. A pedal extension apparatus comprising:
a platform configured to communicate with a top surface of a pedal, the outside dimensions of the platform having the shape of a rectangular parallelepiped, the platform having a top side, a bottom side, a first short side, a second short side, a first long side, and a second long side;
a first vertical retainer coupled to the first long side of the platform, the first vertical retainer having an L-shaped cross-section, the first vertical retainer configured to communicate with a bottom surface of the pedal;
a second vertical retainer coupled to the second long side of the platform, the first vertical retainer having an L-shaped cross-section the second vertical retainer configured to communicate with the bottom surface of the pedal; and
an endplate coupled to the first short side of the platform, the endplate configured to communicate with an end of the pedal, the pedal extension apparatus not including a fastener.
